(19) United States
(12) Patent Application Publication
(10) Pub. No.: US 2013/0248292 A1
(43) Pub. Date: Sep. 26, 2013

(54) Release and Retention of Viscosity Modifiers Based on Oil Temperature

(71) Applicants: Gregory Mordukhovich, Bloomfield Hills, MI (US); Eric W. Schneider, Shelby Township, MI (US)

(72) Inventors: Gregory Mordukhovich, Bloomfield Hills, MI (US); Eric W. Schneider, Shelby Township, MI (US)

(73) Assignee: GM GLOBAL TECHNOLOGY OPERATIONS LLC, Detroit, MI (US)

(21) Appl. No.: 13/426,765

(22) Filed: Mar. 22, 2012

(51) Int. Cl. F16N 39/06; F01M 9/00; B01D 35/02; F16H 57/04; F01D 25/18; F01M 11/03; F01M 1/02; F16N 7/38

(52) U.S. Cl. 184/6.5; 184/6.22; 184/6.12; 184/6.11; 184/6.16; 210/167.02; 210/167.08

(57) ABSTRACT

Disclosed are articles, lubrication systems, and methods that sequester lubricant viscosity modifiers via adsorption of the viscosity modifier molecules onto a molecular sieve material at lubricant temperatures below a threshold temperature and release of the viscosity modifier molecules from the molecular sieve material at lubricant temperatures at about the threshold temperature so that the viscosity modifier molecules are in the lubricant at temperatures from about the threshold temperature and higher. In this way, the viscosity modifier molecules are removed from the lubricant at temperatures where the lubricant has sufficient viscosity but released into the lubricant when they can useful increase the lubricant viscosity because it otherwise would be too low.

### FIELD OF THE SPECIFICATION

The present invention relates to lubrication systems that experience large temperature variations, such as engine lubrication systems, and more specifically to controlling lubricant properties over a wide temperature span.

### INTRODUCTION TO THE DISCLOSURE

This section provides information helpful in understanding the invention but that is not necessarily prior art.

Engine oil lubricates moving components of an engine. For example, oil may lubricate pistons that reciprocate in cylinders, a crankshaft that rotates on bearings, and a camshaft that drives intake and exhaust valves. Oil reduces friction-related wear in the engine. Oil may also coat metal components to inhibit corrosion. A vehicle engine typically includes an oil pan that is mounted to the engine block. Lubricating oil drains from the engine block into and collects in the oil pan sump before being pumped from the oil pan and recirculated through the engine again.

Automotive vehicle engines are operated under a wide range of temperatures. Engine oil creates hydrodynamic drag-related frictional losses when the engine is running. These losses are minimized at a certain viscosity or in a certain viscosity range. The temperature at which the oil is used varies from very cold when an engine is started in winter to very hot after extended operation in summer. Liquids, including engine oils, change viscosity with temperature, typically being less viscous with increasing temperature. Accordingly, oils used for engine lubrication are generally formulated as multigrade oils, which include additives like pour point depressants and viscosity index modifiers, to provide satisfactory lubrication over a fairly broad temperature range, for example SAE 10W-40 and 5W-30 grade oils. Such formulations provide satisfactory, though not optimum, viscosity over much of the temperature range, but the oil viscosity still changes with changes in temperature.

Typical engine oil compositions use a Group I, II, III, a synthetic poly(alpha-olefin) (“PAO”), or mixtures of these as a base oil stock. The groups are broad categories of base stocks developed by the American Petroleum Institute (API). Viscosity modifiers (or viscosity index improvers) that are included in engine oil compositions to help meet standard viscosity requirements are polymeric materials, typical examples of these being hydrogenated styrene-isoprene block copolymers, rubbers based on ethylene and propylene, acrylic polymers produced by polymerization of acrylate and methacrylate esters, and polyisobutylene. These polymeric thickeners are added to bring the viscosity of the base fluid up to that required for the engine oil at high temperatures.

When high molecular weight viscosity modifiers are included in the production of multi-grade lubricants, however, they also increase the viscosities of the lubricants at lower temperatures where they are not needed. Further, extended use of viscosity modifiers may result in a progressive loss of viscosity index and thickening power and in the formation of unwanted deposits and sludge over time. There remains a need for an engine lubrication system that can better control lubricant viscosity over a wide temperature operating range for the engine with longer lubricant lifetime and reduced formation of deposits and sludge.

### SUMMARY OF THE DISCLOSURE

This section provides a general summary rather than a comprehensive disclosure of the full scope of the invention and of all its features.

We disclose articles, lubrication systems, and methods that sequester lubricant viscosity modifiers via adsorption of the viscosity modifier molecules onto a molecular sieve material at lubricant temperatures below a threshold temperature and release of the viscosity modifier molecules from the molecular sieve material at lubricant temperatures at about the threshold temperature so that the viscosity modifier molecules are in the lubricant at temperatures from about the threshold temperature and higher. In this way, the viscosity modifier molecules are removed from the lubricant at temperatures where the lubricant has sufficient viscosity without the viscosity modifier molecules but released into the lubricant when they can usefully increase the lubricant viscosity because it otherwise would be too low. The molecular sieve material has pores sized to adsorb the viscosity modifier molecules at the lower temperatures, and the molecular sieve material is selected to have a thermal expansion behavior in the temperature range over which the lubricant is used such that the pores change in size by about the threshold temperature to an extent needed to desorb or release the adsorbed viscosity modifier molecules into the lubricant. Lubricants containing a viscosity modifier may be, for example, engine oils, transmission fluids, hydraulic fluids, gear oils, marine cylinder oils, compressor oils, refrigeration lubricants, aviation turbine oils, gas turbine oils, passenger car engine oils, commercial vehicle engine oils, industrial, marine, hydraulic, aviation, and driveline oils.

Further provided is an automotive vehicle comprising a lubrication system including a lubricant with a viscosity modifier and the molecular sieve material that adsorbs viscosity modifier molecules below a threshold temperature and desorbs viscosity modifier molecules at about the threshold temperature so that the viscosity modifier molecules are in the lubricant at temperatures from about the threshold temperature and higher.

As one aspect of the technology we disclose a porous structure comprising the molecular sieve material in contact with the lubricant in a lubrication system. In various embodiments, the porous structure may be fixed in a lubricant sump or reservoir, in a line through which lubricant passes in the system, or in a member, such as a filter, through which lubricant passes in the system. In various embodiments, the porous structure may be a membrane or porous solid of any geometric or irregular shape, such as a brick, or may be a filter assembly containing the molecular sieve material in the form of beads or pellets in a compartment of through which lubricant may pass. A filter assembly comprising the molecular sieve material may be a replaceable member in the lubrication system. In various embodiments a porous structure comprising the molecular sieve material is arranged in channels through which lubricant flows.

The molecular sieve material has pores that are sized to adsorb viscosity modifier molecules at temperatures below a threshold temperature and has a thermal expansion behavior causing a change in pore size as the threshold temperature is reached so as to release the viscosity modifier molecules at about the threshold temperature so that the viscosity modifier molecules are in the lubricant at temperatures from about the threshold temperature and higher. The molecular sieve material may be in the form of a membrane or monolith, may be beads or pellets enclosed in a container having screened ends to retain the molecular cell material, or may be beads or powders embedded in an open-cell foam through which the lubricant may flow.

In one aspect, a lubrication system circulating a lubricant is operated over a temperature range having an initial temperature and a higher temperature that is reached during operation. The lubricant includes viscosity modifier molecules. The lubrication system includes a molecular sieve material contacted by the lubricant. Viscosity modifier polymer molecules are adsorbed by the molecular sieve material at the initial temperature but desorb at a threshold temperature between the initial temperature and the higher temperature. The higher temperature is a temperature at which the viscosity modifier polymer molecules increase the viscosity of the lubricant where the viscosity of the lubricant would otherwise be lower than desired. In one embodiment, an automotive vehicle includes the lubrication system operated by the method. In various embodiments, the lubrication system may be an engine lubrication system, a transmission lubrication system, or a rear axle lubrication system. The threshold temperature may be in a range from about 100° C. to about 150° C. and in a specific embodiment the lubrication system is an engine lubrication system and the threshold temperature may be about 120°.

In another aspect, an engine lubrication system includes an engine oil comprising viscosity modifier molecules, a sump or reservoir for the oil, a pump, an uptake line for moving the oil from the sump to the pump, at least one circulation line for carrying the oil from the pump to engine parts to be lubricated, and a molecular sieve material. The molecular sieve material has pores sized to adsorb viscosity modifier molecules at temperatures below a threshold temperature, and the molecular sieve material is selected to have a thermal expansion behavior in the temperature range over which the engine lubrication system operates such that the pores change in size to an extent by about the threshold temperature to desorb or release the adsorbed viscosity modifier molecules into the lubricant. The molecular sieve material may form a part of a porous structure. The molecular sieve material may be fixed at any point in the engine lubrication system.

In the engine lubrication system, the molecular sieve material may be located in the sump, in the uptake line, in a circulation line, or in a filter element. The engine lubrication system may include a loop, branching off of the circulation line for carrying the oil from the pump to engine parts to be lubricated, that carries oil through the molecular sieve, a porous structure comprising the molecular sieve, or a filter element comprising the molecular sieve and returns the oil either to the circulation line or to the sump. If in the sump, the molecular sieve material or article containing the molecular sieve material is attached or secured or immobile so that it will not contact moving engine parts.

In a further aspect, a filter element for the lubrication system, such as a replaceable oil filter, includes a molecular sieve material that has pores sized to adsorb the viscosity modifier molecules at temperatures below a threshold temperature, with the molecular sieve material being selected to have a thermal expansion behavior in the temperature range over which the lubricant is used such that the pores change in size to an extent by about the threshold temperature to desorb or release the adsorbed viscosity modifier molecules into the lubricant.

Further provided is an automotive vehicle comprising the engine lubrication system.

The disclosed system is beneficial for permitting greater control of oil viscosity according to operating temperature, which can improve fuel economy and reduce engine wear. Sequestering all or a part of the molecules of the viscosity modifier from the lubricant until the lubricant reaches a temperature at which the viscosity modifier is useful allows the lubricant to have a lower viscosity at cold temperatures. Lower lubricant viscosity at cold temperatures requires lower cold cranking capacity of the battery. The disclosed lubrication system also reduces the amount of time a viscosity modifier is exposed to mechanical shear and heat, reducing degradation and oxidation of the viscosity modifier and reducing piston deposits and sludge formation associated with the degradation and oxidation. Finally, sequestering the viscosity modifier or modifiers from the lubricant at low temperatures removes the need to use the more expensive expandable viscosity modifiers.

The disclosed system is beneficial for similar reasons in other lubrication applications that experience wide temperature changes during operation, including other automotive vehicle lubrication applications, such as transmission and rear axle lubricant systems; aviation engines and other aviation systems requiring lubrication; turbine engines; machine tools, compressors, and other industrial motors and industrial systems that use lubricants containing viscosity modifiers.

In describing these methods and devices, certain terms are used that have the following meanings.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, or groups of these. The method steps, processes, and operations described herein are not to be construed as necessarily requiring their performance in the particular order discussed or illustrated, unless specifically identified as an order of performance. It is also to be understood that additional or alternative steps may be employed. As used in this specification, the term “or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, section, step, etc. from another region, layer, section, step, etc. Terms such as “first,” “second,” and other numerical terms when used herein do not imply a sequence or order unless clearly indicated by the context.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings are for illustrative purposes only of selected embodiments and not all possible implementations, and are not intended to limit the scope of the present disclosure.

FIG. 1 is a schematic, partial cross-sectional illustration of a typical engine for a motor vehicle employing a lubrication system;

FIG. 2 is a cross-section of one embodiment of a brick of molecular sieve material used in the lubrication system; and

FIG. 3 is a graph of ideal behavior of average pore size of a molecular sieve material configured to adsorb a viscosity modifier having a weight average molecular weight of about 300,000 in a temperature range for operation of an automotive vehicle engine.

### DETAILED DESCRIPTION

A detailed description of exemplary, nonlimiting embodiments follows.

The lubrication system includes a lubricant having a viscosity modifier and a molecular sieve material having a pore size at temperatures below a threshold temperature selected to adsorb molecules of the lubricant viscosity modifier, wherein the molecular sieve material has a thermal expansion behavior causing a change in pore size as the threshold temperature is reached so as to release the viscosity modifier molecules at about the threshold temperature so that the viscosity modifier molecules are in the lubricant at temperatures from about the threshold temperature and higher.

The lubricant may be any of those used as engine oils, transmission fluids, hydraulic fluids, gear oils, marine cylinder oils, compressor oils, refrigeration lubricants, aviation turbine oils, gas turbine oils, passenger vehicle engine oils, commercial vehicle engine oils, industrial, marine, hydraulic, aviation, and driveline oils. The lubricant can range in viscosity from light distillate mineral oils to heavy lubricating oils, such as gasoline engine oils, mineral lubricating oils, and heavy duty diesel oils. Many classes of lubricants are known, including American Petroleum Institute (API) categories of Group I through Group V. The API defines Group I stocks as solvent-refined mineral oils. Group I stocks contain the most unsaturates and sulfur and have the lowest viscosity indices. Group II and III stocks are high viscosity index and very high viscosity index base stocks, respectively. The Group III paraffinic and naphthenic oils such as mineral oils contain fewer unsaturates and sulfur than the Group I oils. Group IV oils are poly(alpha-olefin) (PAO) oils. Oligomers of lower molecular weight olefins such as ethylene and propylene, oligomers of ethylene/butene-1 and isobutylenelbutene-1, and oligomers of ethylene with other higher olefins, as described in U.S. Pat. No. 4,956,122 and the patents it references can also be employed. Group V includes all the other base stocks not included in Groups I through IV, such as lubricants based on or derived from esters (e.g. polyol esters), alkylated aromatics, polyinternal olefins (PIOs), polyalkylene glycols (PAGs), silicone oils, fluorinated oils, and ionic fluids.

Typical automotive engine oil compositions use lubricants from Group I, II, III, PAOs, or mixtures of these as a base oil stock. PAOs are produced via the catalytic oligomerization of linear alpha-olefins, typically monomers having from about 4 to about 30, or from about 4 to about 20, or from about 6 to about 16 carbon atoms. Examples of useful PAOs include oligomers of C5-C14 linear alpha-olefins, especially from 1-hexene to 1-tetradecene, more particularly from 1-octene to 1-dodecene, and mixtures of these. Blends of oligomers of 1-decene are one preferred material. In another embodiment, the base oil comprises mixtures of mineral oils with PAOs. In another embodiment, the base oil comprises a polyinternal olefin (PIO—a group VI base oil).

The lubricant contains a major amount of at least one of these base oils and a viscosity modifier. Viscosity modifiers (or viscosity index improvers) are polymeric materials, typical examples of these being hydrogenated styrene-isoprene block copolymers, hydrogenated copolymers of styrene-butadiene, copolymers of ethylene and propylene, acrylic polymers produced by polymerization of acrylate and methacrylate esters, hydrogenated isoprene polymers, polyalkyl styrenes, hydrogenated alkenyl arene conjugated diene copolymers, polyolefins, esters of maleic anhydride-styrene copolymers, and polyisobutylene. Typical weight average molecular weights of these polymers are between about 1,000 to 1,000,000, more typically about 2,000 to 500,000. These polymeric thickeners are added to bring the viscosity of the base fluid up to the required for the engine oil at high temperatures.

In various embodiments, the viscosity modifier may be a polymer with radial or star architecture, such as those described in Schober et al., US Patent Application No. 2011/0306529, which is incorporated by reference in its entirety, and in the references cited therein, all of which are incorporated herein in their entirety. Such viscosity modifiers may have a random, tapered, di-block, tri-block, or multi-block architecture and may have weight average molecular weights of about 100,000 to about 800,000. As a nonlimiting example, a disclosed embodiment in US Patent Application No. 2011/0306529 is prepared from 50 wt % to about 100 wt % of an alkyl methacrylate, wherein the alkyl group has about 10 to about 20 carbon atoms up to about 40 wt % of an alkyl methacrylate, wherein the alkyl group has about 9 carbon atoms; and up to about 10 wt % of a nitrogen-containing monomer. Other examples of viscosity modifiers that are star polymers include isoprene/styrene/isoprene triblock polymers.

The viscosity modifier may be included in the lubricant in amounts from about 0.001 to about 15 wt % based on total lubricant weight. An engine oil may typically include 1-5 wt % viscosity modifier; in a nonlimiting example an engine oil includes about 2 wt % viscosity modifier.

The lubricant composition optionally includes other performance additives. Nonlimiting examples of other performance additives include metal deactivators, viscosity modifiers, detergents, friction modifiers, antiwear agents, corrosion inhibitors, dispersants, dispersant viscosity modifiers, extreme pressure agents, antioxidants, foam inhibitors, demulsifiers, pour point depressants, seal swelling agents and mixtures thereof. Typically, fully-formulated lubricating oil will contain one or more of these performance additives.

The lubrication system includes a molecular sieve material that adsorbs the viscosity modifier molecules at lubricant temperatures below a threshold temperature and releases the viscosity modifier molecules at lubricant temperatures at about the threshold temperature so that the viscosity modifier molecules are in the lubricant at temperatures from about the threshold temperature and higher.

Molecular sieve materials include zeolites, metal organic frameworks (MOFs), and covalent organic frameworks (COFs). Zeolites are porous structures of aluminosilicate. There are both naturally-occurring and synthetic varieties, the latter being produced by crystallization of silica-alumina gel. Pore size can be affected by controlling the ratio of silica to alumina in the gel and by other factors, such as described in Larsen et al., US Patent Application Publication No. US 2012/0027673 and in Garcia-Martinez, US Patent Application Publication No. US 2012/0024776.

Manufacture and characterization of zeolites and other molecular sieves are well-known and described, for example, in Scott M. Auerback, “Handbook of Zeolite Science and Technology”; W. W. Wong, “Handbook of Zeolites: Structure, Properties, and Applications”; H. Van Bekkum, “Introduction to Zeolite Science and Practice”; Rosemarie Szostak, “Handbook of Molecular Sieves”; and Helmut G. Karge, “Molecular Sieves: Science and Technology,” the entire contents of each being incorporated herein by reference. Zeolites are manufactured by crystallization from aluminum hydroxide, sodium hydroxide, and water glass. Under carefully controlled conditions, the crystallization process produces the required sodium aluminosilicate structure. The formed zeolite crystals can then be ion exchanged, if need be, to adjust the pores to a desired size. After drying, the zeolite crystals can be processed to activated zeolite powder, beads, or monoliths using well-known methods. A monolith can be used in the lubricant and lubrication system as such. Zeolite powders or beads may be enclosed in a lubricant-permeable container, or attached or molded onto a surface, such as molded into a lubricant-permeable foam.

Other classes of porous crystals are Metal-Organic Framework (MOFs), Zeolitic Imidazolate Frameworks (ZIFs), Covalent Organic Frameworks (COFs), and Metal Organic Polyhedra (MOPs). Generally speaking, MOFs are crystalline compounds consisting of metal ions or clusters coordinated to often rigid organic linking molecules to form one-, two-, or three-dimensional porous structures. Based on the combination of the building blocks, the length, the combination and the functionalization of the organic linker, a large variety of pore environments can be made. MOFs may have large surface areas and are relatively easy to adapt for specific applications. More information is available in Stuart L. James, Chem. Soc. Rev., 2003 32, 276-288, which is incorporated herein by reference.

COFs, covalent organic frameworks, are described for example in Yaghi et al., US 2006/0154807 and 2010/0143693; Apitler et al., “A 2D Covalent Organic Framework with 4.7-nm Pores and Insight into Its Interlayer Stacking,” J. Am. Chem. Soc., 2011, 133(48), pp. 19416-21 (Dec. 7, 2011); Adrien P. Côté et al., “Reticular Synthesis of Microporous and Mesoporous 2D Covalent Organic Frameworks,” J. Am. Chem. Soc. 2007 129, 12914-12915; Hani M. El-Kaderi et al., “Designed Synthesis of 3D Covalent Organic Frameworks,” Science, Vol. 316, 13 Apr. 2007, pp. 268-272; Adrien P. Côté et al., “Porous, Crystalline, Covalent Organic Frameworks,” Science, Vol. 310, 18 Nov. 2005, pp. 1166-1170; and Joon-Sung Ahn et al., “In situ Temperature Tunable Pores of Shape Memory Polyurethane Membranes,” Smart Materials and Structures, Vol 20, No. 10, 2011, each of which is incorporated herein by reference.

The pore size of molecular sieve within a temperature range is chosen based on the molecule size of the lubricant species that is targeted for adsorption. The molecular sieve material or materials may be designed based on pore size requirements and multi-cycle durability requirements.

The molecular sieve material may be in the form of a membrane or monolith, may be beads or pellets enclosed in a container having screened ends to retain the molecular cell material, or may be beads or powders embedded in an open-cell foam through which the lubricant may flow.

The molecular sieve may be a part of a porous structure in contact with the lubricant in a lubrication system. In various embodiments, the porous structure may be a membrane or porous solid or monolith of any geometric or irregular shape, such as a brick, or may be a filter assembly containing the molecular sieve material in the form of beads or pellets in a compartment of through which lubricant may pass. A filter assembly comprising the molecular sieve material may be a replaceable element in the lubrication system. In various embodiments a porous structure comprising the molecular sieve material is arranged in channels through which lubricant flows. In an embodiment, the molecular sieve material is a part of an oil filter; a fraction of oil flows through the molecular sieve material, while the remainder of the oil flows through regular size pores (e.g., 20 micrometers) of an oil filter

In various embodiments, the lubrication system includes a fluid pump positioned to draw lubricant past and through the molecular sieve material and to circulate the lubricant to the areas where it is needed. In various embodiments, the lubrication systems include a lubricant or oil sump, and the pump may be positioned to draw lubricant or oil from the sump to circulate pressurized lubricant to the place or places where lubrication is required, then return the lubricant to the sump. In an automotive engine, the oil pump circulates the oil from the sump to the engine parts needing lubrication, after which the oil is returned to the sump by gravity flow.

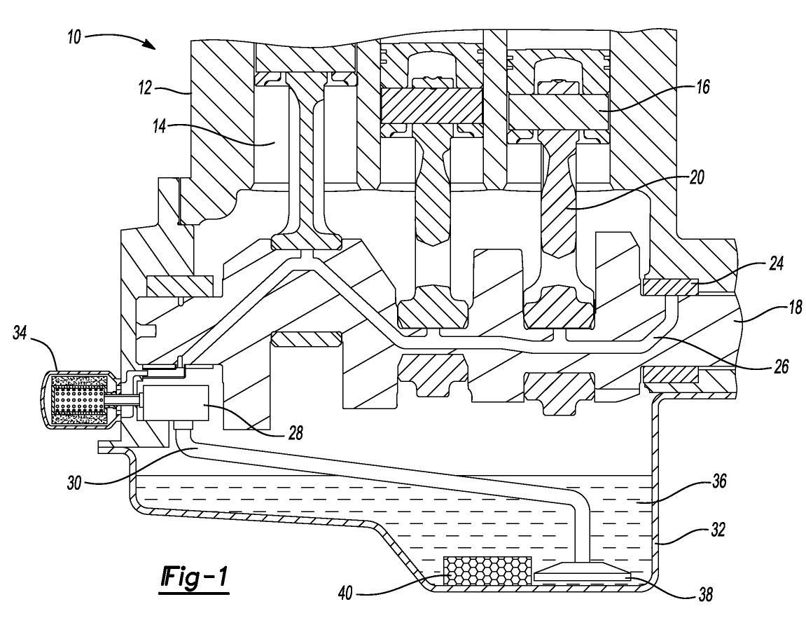

Referring now to the automotive vehicle internal combustion engine shown partially in FIG. 1, engine 10 includes a cylinder case 12 defining a plurality of cylinders 14, each operable to receive a piston 16 for reciprocal motion therein. Each piston 16 imparts torque to a crankshaft 18 via a connecting rod 20 as a result of force generated by combustion of an air-fuel mixture inside each respective cylinder 14. Each connecting rod 20 is rotationally supported on the crankshaft 18 via a rod bearing 22. The crankshaft 18 is rotationally supported in the cylinder case 12 via main bearings 24.

Engine 10 employs a lubrication system 26 having fluid passages or galleries for supplying oil to rod bearings 22, main bearings 24, and other moving parts (not shown). The fluid passages of lubrication system 26 are supplied with oil 36 via an oil pump 28, which first pumps the oil through an oil filter 34. The oil pump 28 employs a pick-up structure 30 projecting from the pump 28, typically concluding with a steel mesh screen 38 to filter out debris, for receiving oil from an oil pan sump 32. Sump 32 contains a brick of molecular sieve material 40, which is attached to sump 32 so as not to interfere with operation of the engine.

Brick 40 comprises a molecular sieve material configured to adsorb and hold viscosity modifier molecules of a particular size in a specific temperature range from a temperature at which engine operation commences until a higher, threshold temperature. The molecular sieve will adsorb the viscosity modifier molecules until its pore size changes, due to a thermal expansion characteristic of the selected molecular sieve material, which may be determined, for example, as explained in D. S. Bhange et al., “High Temperature Thermal Expansion Behavior of Silicalite-1 Molecular Sieve: In Situ HTXRD Study,” Micropor. Mesopor. Mater., 2007; D. S. Bhange et al., “Negative thermal expansion in silicalite-1 and zirconium silicalite-1 having MFI structure,” Materials Research Bulletin 41 (2006) 1392-1402; M. Lassinantti Gualtieri et al, “Accurate Measurement of the Thermal Expansion of MFI Zeolite Membranes by in situ HTXRPD,” Studies in Surface Science and Catalysts, Vol. 154, Part A, 2004, pp. 703-709; B. A. Marinkovic et al. “Negative Thermal Expansion in Hydrated HZSM-5 Orthorhombic Zeolite,” Microporous and Mesoporous Materials 71 (2004) 117-124; Sang Soo Han et al., “Metal-Organic Frameworks Provide Large Negative Thermal Expansion Behavior,” J. Phys. Chem. C, 2007, 111, 15185-15191; and Lei Zhao et al, “Negative Thermal Expansion in Covalent Organic Framework COF-102,” J. Phys. Chem. C, 2009, 113 (39), pp. 16860-16862, all of which are incorporated herein in their entirety by reference.

When the molecular sieve material has a positive thermal expansion with increasing temperature in the operating temperature range, the adsorbent pore size is sized to adsorb the viscosity modifier molecules below the threshold temperature, and the molecular sieve material expands at the threshold temperature to a size that permits the viscosity modifier molecules to desorb from the pores. When the molecular sieve material has a negative thermal expansion with increasing temperature in the operating temperature range, the adsorbent pore size decreases at the threshold temperature to force the adsorbed viscosity modifier molecules in its pores to desorb into the lubricant.

Brick 40 may be attached to the sump by a fastener, adhesive, held within a strap or mesh restraint, by being formed with piece that slides into a slot, or otherwise connects onto a fixture in the sump, or by another method. Preferably, the attachment is mechanical to avoid any contamination of the oil by chemicals from an adhesive.

In other embodiments (not shown), the molecular sieve material may have other shapes or may be of other sizes relative to the sump. In one embodiment, the molecular sieve material may substantially fill the sump. The molecular sieve material may also be embedded as nodules in anther material such as a foam or may be powder or beads contained in a porous enclosure.

A brick or other shape or form of molecular sieve material may be located in another part of the engine lubrication system instead of or in addition to being in the sump. For example a molecular sieve material may be in a fluid passage of the lubrication system 26 or may be located in a separate loop added to the lubrication system to contain the molecular sieve material.

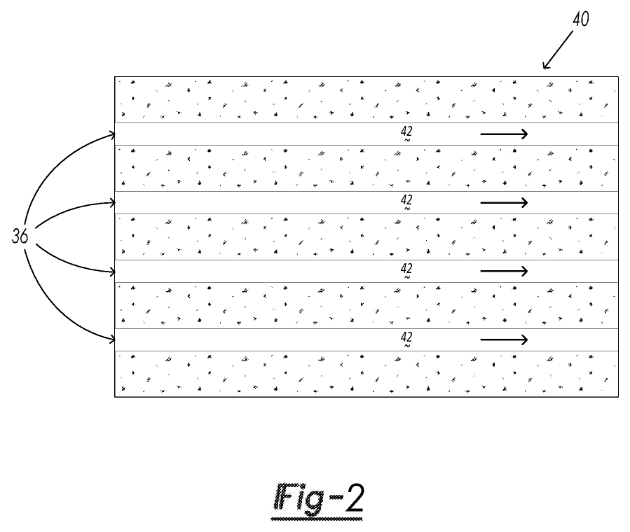

As shown in FIG. 2, brick 40 may include internal passages or channels 42 through which the oil 36 may flow. The internal channels increase the effective surface area of molecular sieve material with pores sized to adsorb the viscosity modifier molecules.

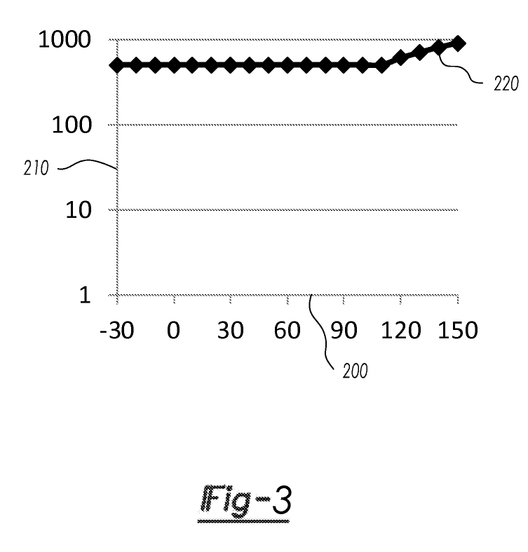

FIG. 3 shows one exemplary behavior for a lubrication system having a molecular sieve material for adsorbing and desorbing a viscosity modifier. In FIG. 3, y-axis 210 is the average pore size of the molecular sieve material, in nanometers; x-axis 200 is lubricant temperature, in degrees C. As shown in FIG. 3, the molecular sieve material, indicated by line 220, adsorbs the viscosity modifier molecules until the lubricant temperature reaches about 120° C., when the pores of the molecular sieve material expand sufficiently to allow the viscosity modifier molecules to desorb from the molecular sieve material to mix in the lubricant.

In another embodiment, the lubrication system is a transmission lubrication system. A transmission lubrication system includes a transmission fluid sump or reservoir, pump, pickup and transmission fluid distribution system. The molecular sieves may be located in the sump or in a separate unit in fluid connection with the transmission fluid distribution system. In yet another embodiment, the lubrication system is a lubrication system for an automotive vehicle driveline differential, which includes a sump containing gear oil. The molecular sieve material or materials may be located in the sump.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A lubrication system in a machine comprising
(a) a lubricant comprising a viscosity modifier;
(b) a sump for the lubricant;
(c) a pump that circulates the lubricant from the sump in a lubricant line to an area of the machine for lubrication, from which area the lubricant returns to the sump; and
(d) a molecular sieve material in the lubrication system that adsorbs viscosity modifier molecules at lubricant temperatures below a threshold temperature and releases the viscosity modifier molecules at lubricant temperatures at about the threshold temperature so that the viscosity modifier molecules are in the lubricant at temperatures from about the threshold temperature and higher.

2. A lubrication system in a machine according to claim 1, wherein the molecular sieve material is in the sump.

3. A lubrication system in a machine according to claim 1, wherein the molecular sieve material is in the lubricant line.

4. A lubrication system in a machine according to claim 1, further comprising a loop branching off of the lubricant line, wherein the loop carries the lubricant through the molecular sieve material, a porous structure comprising the molecular sieve material, or a filter element comprising the molecular sieve material and returns the lubricant either to the circulation line or to the sump.

5. A lubrication system in a machine according to claim 1, wherein the lubrication system is for an engine, a transmission, gears, a compressor, a turbine, or a driveline.

6. A lubrication system in a machine according to claim 1, wherein the molecular sieve material, the porous structure comprising the molecular sieve material, or the filter element comprising the molecular sieve material is mechanically affixed in the lubrication system.

7. A lubrication system in a machine according to claim 1, wherein the molecular sieve material is selected from zeolites, metal organic frameworks, and covalent organic frameworks.

8. A lubrication system in a machine according to claim 1, wherein the machine is an automotive vehicle, an aircraft, a ship, a boat, a locomotive, a motorcycle, or a machine tool.

9. A filter element, comprising a molecular sieve material that adsorbs viscosity modifier molecules temperatures below a threshold temperature and releases the viscosity modifier molecules at temperatures at about the threshold temperature, wherein the filter element is configured for attachment in a lubrication system.

10. An oil filter for an internal combustion engine comprising a filter element according to claim 9.

11. An automotive vehicle comprising the oil filter of claim 10.

12. A method of controlling viscosity of a lubricant comprising a viscosity modifier over an operating temperature range of a lubrication system, the method comprising
circulating the lubricant in the lubrication system over the operating temperature range, wherein the range has as endpoints an initial temperature and a higher temperature that is reached during operation, and
contacting the lubricant with a molecular sieve material, wherein viscosity modifier polymer molecules are adsorbed by the molecular sieve material at the initial temperature and at temperatures between the initial temperature and a threshold temperature lying between the initial but the viscosity modifier polymer molecules desorb at the threshold temperature so that the viscosity modifier polymer molecules are in the lubricant at temperatures from about the threshold temperature to the higher temperature.

13. A method according to claim 12, wherein the molecular sieve material is in the form of a membrane, a monolith, beads enclosed in porous structure having screened ends to retain the molecular cell material through which the lubricant may flow that may be a part of a lubricant system filter element, or beads or powders embedded in a porous structure that is an open-cell foam through which the lubricant may flow.

14. A method according to claim 12, wherein the molecular sieve material, the porous structure comprising the molecular sieve material, or the filter element comprising the molecular sieve material is mechanically affixed in the lubrication system.

15. A method according to claim 12, wherein the threshold temperature is in a range from about 100° C. to about 150° C.

16. A method according to claim 12, wherein the threshold temperature is about 120° C.

17. A method according to claim 12, wherein the lubrication system is operated as part of an automotive vehicle.

18. A method according to claim 12, wherein the lubrication system is operated as part of an internal combustion engine.

19. An automotive vehicle, comprising an engine oil lubrication system comprising an engine oil comprising viscosity modifier molecules, a sump for the oil, a pump, an uptake line for moving the oil from the sump to the pump, at least one circulation line for carrying the oil from the pump to engine parts to be lubricated, and a molecular sieve material,
wherein the molecular sieve material has pores sized to adsorb viscosity modifier molecules at temperatures below a threshold temperature, and the molecular sieve material is selected to have a thermal expansion behavior in a temperature range such that the pores change in size to an extent by about a selected threshold temperature to desorb or release the adsorbed viscosity modifier molecules into the lubricant.

20. An automotive vehicle according to claim 19, wherein the molecular sieve material is in the form of a membrane or a monolith or is in the form of beads enclosed in a container having screened ends to retain the molecular cell material through which the lubricant may flow or beads or powders embedded in an open-cell foam through which the lubricant may flow.
